(19) United States
(12) Patent Application Publication
(10) Pub. No.: US 2017/0337287 A1
(43) Pub. Date: Nov. 23, 2017

(54) Intelligent integrating system for crowdsourcing and collaborative intelligence in human- and device- adaptive query-response networks

(71) Applicant: Susan (Zann) Gill, Los Altos, CA (US)

(72) Inventor: Susan (Zann) Gill, Los Altos, CA (US)

(21) Appl. No.: 15/628,536

(22) Filed: Jun. 20, 2017

Related U.S. Application Data
(63) Continuation-in-part of application No. 14/133,235, filed on Dec. 18, 2013, now Pat. No. 9,712,576.
Application No. 14/133,235 is a continuation of application No. 12/817,167, filed on Jun. 16, 2010, now Pat. No. 8,639,650.
Application No. 12/817,167 is a continuation-in-part of application No. 11/733,736, filed on Apr. 10, 2007, now Pat. No. 7,853,551.
Application No. 11/733,736 is a continuation-in-part of application No. 10/602,824, filed on Jun. 25, 2003, now abandoned.

(51) Int. Cl. G06F 17/30; G06Q 10/10; G06Q 10/06

(52) U.S. Cl. CPC G06F 17/30867; G06F 17/3087; G06F 17/30598; G06F 17/30283; G06Q 10/06398; G06Q 10/103

(57) ABSTRACT

Provided is a computer-implemented system and method for a requester-provider, distributed exchange network that augments internet-based social networks for crowdsourcing, rapid updating, decision support, problem-solving, reporting, and impact-tracking for transaction management and status updates for large distributed and/or co-located request-responder networks and crowdsourcing solicitations, such that an Intelligent Integrating System (ISS) can match, network and cluster related components on the knowledge platform, whether private or public, such that relevant information can be personally targeted or broadcast, timely, tagged, and geo-localized, enabling users to contribute and respond to requests using natural language, receive postings customized to their needs and preferences, share information, assess alternatives, integrate crowd-sourced resources and process transactions across distributed human-machine systems running on a diversity of computer, mobile and device platforms. Further disclosed is a reconfigurable crowd-sourcing requester-responder system and knowledge platform to respond to requests or crowd-sourced challenges, said system comprising: a processor; a storage element coupled to the processor; encoded instructions; wherein when executed, the system is configured to: receive a request from a task requestor; tag said request into at least one of a category, group, sort, class, and, or sub-class; apply query-forwarding rule to forward the tagged request to at least one topic channel, wherein the tagged request is expert-sourced to at least one responder meeting the required credentials for a given request; track usage of requesters and responders by at least one of the following identifier tags: geographic-location data, timestamp data, topic tagging, and user profile; publish responder's entry for at least one of commenting, rating, and, or voting or maintaining anonymity of responder, as designated; and wherein usage causes an operational state change of at least one of the query, the query-forwarding rule, credentials, and, or a project requisite.

### CROSS REFERENCE TO RELATED APPLICATIONS

This application is a continuation-in-part of co-pending U.S. Patent Application entitled Crowd-Sourced Project and Transaction Management System For Human- And Device-Adaptive Requester-Provider Networks (Ser. No. 14/133,235), which is a continuation of issued U.S. Pat. No. 8,639,650 B1 entitled “Profile-Responsive System for Information Exchange in Human- and Device-Adaptive Query-Response Networks for Task and Crowd Management, Distributed Collaboration and Data Integration, Ser. No. 12/817,167 filed on Jun. 16, 2010, which is a continuation-in-part of U.S. Patent Application entitled “Natural Language Knowledge Processor Using TRACE Or Other Cognitive Process Models”, Ser. No. 11/733,736 filed on Apr. 10, 2007, which is a continuation-in-part of U.S. Patent Application entitled “TRACE Cognitive Process Model And Knowledge Processor”, Ser. No. 10/602,824, filed on Jun. 25, 2003 which claims priority from U.S. Provisional Patent Application No. 60/391,861 filed on Jun. 25, 2002 and also claims priority from U.S. Provisional Patent Application No. 61/187,485 filed on Jun. 16, 2009, and incorporates those applications herein by reference for all purposes.

### FIELD OF INVENTION

The invention provides a means to use diverse computing and mobile device client platforms to grow and manage a network for crowdsourcing natural language contributions to a knowledge platform with multiple channels dedicated to different categories of users, co-producing content to evolve the database of an Intelligent Integrating System (IIS). The platform includes a task requester and responder network for distributed problem-solving, augmenting internet-based social and project management networks such that those networked can collaborate via mobile devices, computers or other means to exchange timely, geo-located, topical, personally-targeted information, identify alternative scenarios and cluster choice sets, conduct voting, decision analysis, and evaluate tradeoffs, using cost benefit analysis.

### BACKGROUND

Efforts in the field of the current invention have focused on automating problem-solving in data processing networks such that service requesters are routed to the correct service provider agent. Typically, such systems rely on the computer system's capacity for pattern recognition and requester-provider matching. The subject invention addresses the challenge to create a human computation system that harnesses human pattern recognition capacities where needed via a graphical user interface that engages human pattern recognition skills and delegates to the computer only tasks that the computer can effectively perform. Typical systems are hierarchical, with top-level decision-making agency that hands down through the system. The subject invention enables browsing, whereby the user can choose among alternatives offered. Methods exist that use an interactive, or rule-based, processor to annotate (or tag) text with the symbols and vocabulary of a hypertext markup language, enabling the user to manipulate and view that information in different formats and at different levels of detail. The subject invention addresses the need for methods that effectively combine automated tagging with human recognition and rating systems that can be coupled with a range of project management tracking tools.

Advances in ubiquitous mobile computing make it possible to provide networked services to a distributed, diverse network of users including, but not limited to, project managers, discipline experts, implementers, and incentivized or gamified contributor systems, such as competitions. The rapid development and customization of web applications serving mobile devices, and of geo-aware systems, enables a user network to implement just-in-time knowledge-sharing and response. As collaborative platforms implement game-like attributes to increase user engagement, social networks evolve into next generation user-responsive information systems, collaborative problem-solving networks that can integrate multiple co-dependent services. Geo-locators, tags, channels, and timestamps are used to coordinate timely, effective response to queries and project management demands requiring capacity for rapid updating and adaptation to new data.

The subject invention uniquely integrates attributes of collective intelligence, swarm intelligence, crowd-sourcing, human computation, and collaborative intelligence as defined below. Computer scientists developed collective intelligence algorithms to deliver better-than-average predictions in response to generally quantitative questions, such as “What will the price of DRAM (Dynamic Random Access Memory) be next year?” Anonymous responses are processed using pre-set algorithms. Swarm intelligence shifts from processing static data supplied by anonymous contributors, whose role ends after contributing their responses to a single question, to coordinating, dynamic behaviors engaging multiple agents through time. Swarm intelligence characterizes how autonomous entities, whether natural or artificial, manifest autonomous algorithmic behavior in response to uniform rules, defined and expressed in non-uniform contexts such that coordinated, synergistic intelligence emerges. Swarm intelligence offers a technology whereby distributed individual contributors together consistently outperform single individuals. Human computation combines automation with human skills. Crowdsourcing broadcasts beyond the individual user to engage a diversity of distributed talent. A leader reaches out to a crowd, which is engaged by the system to perform work. Collaborative intelligence builds on the foundation of swarm intelligence and human computation but, whereas in both swarm intelligence and human computation the performers of work are anonymous, collaborative intelligence adds to these anonymous user systems the identifying signatures (original profile in the system) and footprints (profile evolution based on actions taken in the system) of human and device agents in the system. Collaborative intelligence reaches a diverse pool of generally non-anonymous, credited, time-stamped contributors using a natural language system, which may include qualitative input. The complementarity across the systems defined above is that enabling anonymous input allows critical data to be entered in cases where data entry could cause personal risk to an identified contributor (e.g. reporting a health hazard or compliance failure). In such cases contributors choose anonymity. In other cases, data interpretation and use can be improved by knowing the source of the data in case further information is needed. In instances where an invention or idea is disclosed by an employee, the system allows the source to be credited and the data entry timestamped to establish priority and credit. Where appropriate, the anonymity of system users, who can access the system from diverse computing and mobile device client platforms, is maintained by a back end that supports both anonymity and acknowledged identity.

Cross-disciplinary problems require the collaborative intelligence of diverse skills to address complex problems, such as environmental emergency and remediation, e.g. to respond to a hurricane or earthquake, which requires coordinating distributed, cross-disciplinary teams to achieve effective collaboration amongst non-anonymous persons with diverse expertise, across different disciplines, organizations and locations. Such distributed networks comprised of human and computer agents can evolve into future distributed collaborative responder systems to address a broad array of needs, ranging from service and commodity provision to social and professional knowledge-sharing, security and safety in environmental hazards with potential to harness geo-aware devices, sensor networks and distributed, situation-aware technology.

The present invention differs from the prior art in that it exploits the complementarity of collective intelligence, swarm intelligence, crowd-sourcing, human computation, and collaborative intelligence, enabling integration of computer-automated tasks (suitable for collective intelligence) with human pattern recognition tasks (required for collaborative intelligence). To harness the collaborative intelligence of diverse participants entails automated tagging of user profiles as well as capacity for human tagging and to credit individual contributions in a knowledge processing system wherein users share information, personal ratings, recommendations, assessments, and other communications.

### SUMMARY

The present invention provides a non-transitory, computer-implemented system to support distributed knowledge-sharing, rapid updating, and collaborative problem-solving using natural language via web applications, mobile devices, computers or other such devices on a network, which may be in the cloud, wireless, a wide area or local area network, the internet, intranet, and across diverse social networks, including, but not limited to, a private network, such as a localized community, a gaming network or competition framework, a virtual private network, social or professional network, or a network of networks.

Supporting task, project, program, and distributed team or crowd-sourcing challenges, product and service networks, the subject invention serves multiple categories of users, cross-referencing categories and User Profiles, comprised of User Signatures, the user's selections when setting up or revising his profile, and User Footprints, the sum total of the user's actions in the system such that the system can assess relevancy, user preferences, and make recommendations. In one embodiment the system can provide information and just-in-time alerts, responding to user-stated preferences, user activity, and click profile. The original user-entered signature is the initial component of the evolving user profile. The second component is the user footprint, which is augmented through user activities in the system and ratings by others, such that the system can respond more effectively to user capabilities, preferences, and needs. User entries and audit trails augment explicit preference settings as implicit preference indicators stored in computer-readable memory. Content is searchable and can be retrieved using key words or ontologies. User identities, as in social networks, include profiles and tags, but users may also choose an anonymous setting. Different protocols apply to signed versus anonymous settings.

Entries and queries can be structured by the software of the Intelligent Integrating System (IIS) to provide directed guidance to achieve convergent problem resolution, bypassing roadblocks of conventional, consensus-driven collaborative process models by enabling discrete responders on the network to input independent interpretations of data, weightings of alternatives, assessments and other views, unconstrained by pressure for consensus from the group. Query structuring may be automated or allow human judgment, in either case implementing an iterative query system where responses can be tagged, shown on a concept map or geographic map as needed, associated with the evolving profile of the contributor, and integrated by the Intelligent Integrating System. Expert users trigger the system to launch more sophisticated rules, queries, and levels of participation or gameplay, such that the system credits excellence, enabling credits in the system to contribute to user performance evaluation, which can be translated into salary bonuses when implemented as part of an employee performance review system and into incentives and rewards when part of a game system.

A backend database supplies computer-readable memory to support an Intelligent Integrating System (IIS), which sorts and tags user profiles, providing multiple channels and levels of authoring and access for a growing, evolving, distributed, collaborative, social, “serious gaming,” and/or professional network, implemented on non-transitory devices. IIS process records monitor levels and types of participation, such that the system evolves toward more effective performance. The subject invention offers capacity to serve and track one-to-one, one-to-some, and one-to-many alerts, notifications, broadcasts, and task requests, to integrate in memory and to access and distribute relevant information, alerts, and program updates, customized to user profiles and preferences. Where used in a task distribution network, tasks are distributed to first qualified responders, canceling, and so avoiding, duplicate responses. Task requests can be crowd-sourced to multiple responders meeting the required credentials for a given data interpretation task, or allocated via a bidding platform to perform task requests. The subject invention enables efficient project performance for professional networks, such as doctors in a home visit network, or social networks, such as competitors in a challenge. Shared activities range from transactional management to gamified collaborative networks, to events and community services, such as health care or emergency responder systems, or the exchange of goods and services.

### BRIEF DESCRIPTION OF THE DRAWINGS

The drawings illustrate the design and utility of embodiments of the present invention in which similar elements are referred to by common reference numerals. However, the drawings depict only some embodiments of the invention, and should not be taken as limiting its scope. With this caveat, embodiments of the invention will be described and explained with additional specificity and detail through the use of the accompanying drawings in which:

FIG. 1 shows an abstracted conceptual diagram for one embodiment of the invention, a knowledge platform used in a cloud computing environment, serving and receiving from diverse non-transitory devices, channeling data from users with diverse profiles, belonging to different user categories. The subject invention networks a range of non-transitory computing systems 11, ranging from mobile devices 12 and server platforms 15 connecting different categories of user channels (13 A, B, C, D, E) in the cloud 14 and/or across wireless, wide area, and local area networks.

FIG. 2 shows a Knowledge Platform 27, serving and receiving from diverse devices and user channels, all components of an Intelligent Integrating System, whether co-located, or distributed, all operating on the data in the system 16.

FIG. 3 shows one embodiment of the invention, with nine buttons identified by icons represented on a mobile device touch screen, or other user interface applicable for, but not limited to, a gameplay interface, conference and trade show information systems, contributor-receiver systems, task requester-service provider systems (where service requesters may also be service providers). All nine icons can be addressed, starting in the upper left-hand corner, circling clockwise, ending with the central icon for Alerts+Starting Now, calling for immediate action.

FIG. 4 shows one embodiment, wherein each icon of the graphical user interface links to a feature set associated that icon, organizing mnemonic icons in a graphical user interface, where each icon can open scroll or dropdown menus with the feature set of the system represented by that icon.

FIG. 5 shows how the system handles a generic user request with a logical flow diagram from the Task Requester to the Responder in a transactional embodiment of the subject invention.

FIG. 6 shows how the configuration of the user interface for one embodiment of the present invention structures the problem-solving process. Used in this embodiment to match task requesters with task providers wherein the same icon is used by the task requester and also by the task provider, FIG. 6 describes one embodiment wherein the icons 51-59 may offer pull-down menus. action or, as in another embodiment shown in FIG. 6, enabling the user to submit/broadcast to the network.

FIG. 7 shows a logical flow diagram in a multi-channel system wherein the Intelligent Integrating System (IIS) sorts, tags, timestamps and forwards a user request or entry to one or more channels for processing.

FIG. 8 shows the system components and architecture for one embodiment of the invention wherein user-generated content is allocated to channels that serve different user roles and needs, offering different levels of permissions and authorship.

FIG. 9 shows a simplified flow diagram for the TRACE cognitive model and knowledge processor driving iterative cycles that update the Intelligent Integrating System, which provides capacity for Impact Tracking.

FIG. 10 illustrates a generic graphical user interface for an embodiment of the present invention for collaborative problem-solving, using the TRACE Cognitive Model and Knowledge Processor and indicating icon categories for different stages of problem-solving, which can be customized for different applications and user groups.

FIG. 11 shows how the TRACE Model is correlated with the Objects 76, Attributes, 77, Procedures 78, Networks 79, and Assessments 80 that support the Intelligent Integrating System and one embodiment to support application to a Task Requester-Responder network.

FIG. 12 shows how another embodiment applied in a crowd-sourced competition or problem-solving challenge.

FIG. 13 shows one embodiment for a user interface to support human tagging and classifying entries added to the system.

### DETAILED DESCRIPTION

The invention described herein uses the term device to describe any non-transitory terminal with computing capability and memory, including a personal computer, navigation device, tablet, wireless mobile device, cell phone, smart phone, media player, television set top box, or other networkable device. The term client refers to software programs or applications that can be implemented on a terminal, ranging from transactional exchange programs to games to mobile applications (or apps). The term server describes one or more computers configured with server functionality, including capacity to receive and process requests, route responses, organize, tag, categorize, map, and manage data, and execute analytics, including storing and updating user profiles based on users' history of activity in the system. The term processor can include multiple cores for multi-thread or parallel processing. The storage medium may include memory modules, e.g. Read-Only Memory (ROM), Random Access Memory (RAM), flash memory modules, and mass, distributed or cloud storage. Display devices offer a graphical user interface (GUI), such as geographical maps, concept maps, display of task data or “gameboard.” The term platform refers to the customization of selected components and systems to serve a given problem-solving task, or set of tasks. The term bid refers to any offer from a provider on the platform, which may include resources, proposals, assessments, data analysis or other provider contributions. Diverse users, e.g. requesters and providers, apply their different capacities for pattern recognition and selection to navigate, choose options, and contribute, thereby evolving through their participation both their own profiles and the Intelligent Integrating System. The term Intelligent Integrating System (ISS) designates the integrated performance and evolution over time of the components and systems of the subject patent. As the ISS learns, it improves its capacity to generate automated responses and to support a growing, diversified network. In some embodiments, it learns via machine learning and, or probabilistic learning techniques. In the following description, for purposes of explanation, numerous specific details are set forth in order to provide a thorough understanding of the invention. It will be apparent, however, to one skilled in the art that the invention can be practiced without these specific details.

The subject invention comprises a plurality of non-transitory components and systems that together can support both collective intelligence and other methods that process data from anonymous users, and collaborative intelligence methods wherein participant contributions are credited and tagged to individual contributors such that they become searchable “contributor footprints” (the total record of contributor actions in the system) enabling performance evaluation and providing capacity for the Intelligent Integrating System to cluster like users into subgroups, on which various automated procedures can be performed including, but not limited to, statistical analysis, predictive calculations, market and risk analysis, rating, tallying, grouping, tagging, sorting, linking contributor and receiver user profiles, aggregating, integrating, targeting, publishing, retaining as confidential etc. Furthermore, in some embodiments, the system may facilitate secure transactions over the responder-requester network via a distributive digital ledger, such as a block chain. Each responder/requester may represent an individual node along the digital ledger, whereby the transaction can not be altered retroactively without colluding any, and all, subsequent transactions in the network.

The Intelligent Integrating System uses a natural language system to elicit, receive, and organize information from multiple channels and to deliver information as needed in response to user requests, profiles, preferences and past usage activity in the system. Non-structured natural language queries and responses can be converted to structured components that can be tagged, analyzed, searched, clustered, sorted and integrated to satisfy activity requirements, user preferences, problem-solving constraints and trade-offs in order to deliver information as needed in response to user requests, profiles, preferences and past usage activity in the system.

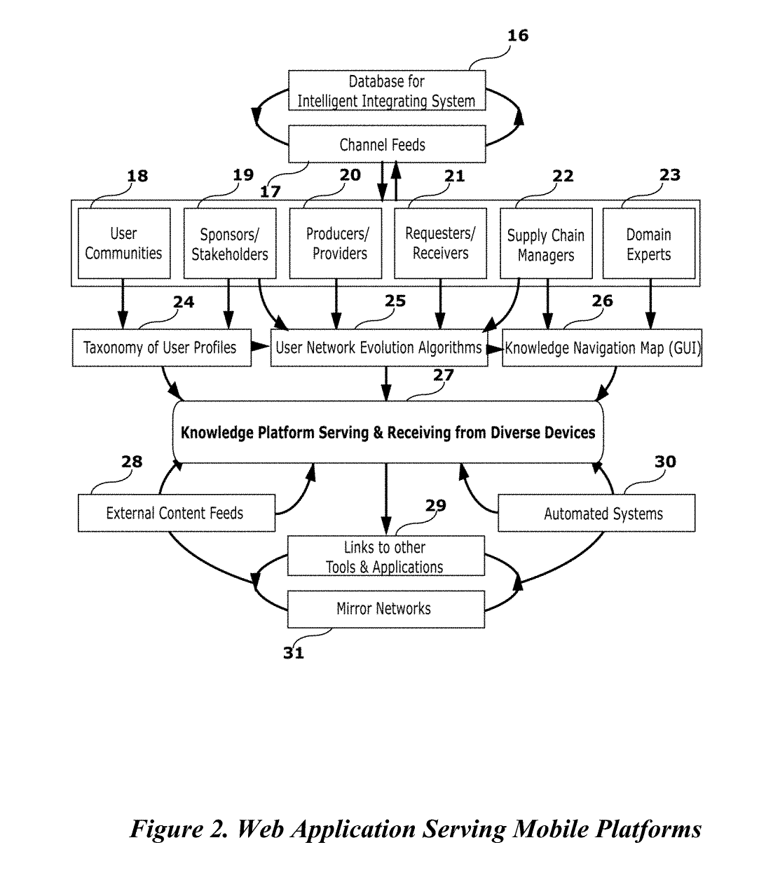

The TRACE Cognitive Model provides an iterative system to guide a plurality of contributors in a coordinated, collaborative problem-solving process where problems range from, but are not limited to Tasks, Competitions, Requester-Responder transactions, and Events. As shown in FIG. 2, the system aids in identifying Task Performers who are Domain Experts 23. The Impact Tracker can check off tasks performed, annotate project status, trigger broadcast alerts, filtering and sorting content, tracking worker performance and retaining profiles of workers for future performance evaluation. The TRACE Model and Impact Tracker can guide a plurality of users with divergent views toward a convergent problem resolution, where convergence is defined as the optimization of a plurality of diverse contributions whereby joint contributors to task performance, User Communities 18, Sponsors/Stakeholders 19, Producers/Providers 20, Requesters/Receivers 21, Supply Chain Managers 22, and Domain Experts 23 do not perform the same roles, nor contribute the same expertise. This method does not require consensus on all aspects of the task for contributors to perform their particular roles in a collaborative ecosystem, and so bypasses roadblocks of conventional, consensus-driven collaborative process models. Discrete responders on the network can maintain independent views. As in evolution, genetic diversity, promotes more robust solutions.

Each round of responses serves as the basis for automated generation of future queries based upon previous query responses, comprising the steps of:
retrieving query responses from an individual agent or from group(s) of agents;
segmenting each response into key phrases;
scanning each phrase for patterns already in the pattern library, and for new patterns that need to be archived;
producing a query generator for each query response grouping found, or selecting a query generator from among those that respond to similar response profiles.

One embodiment of the subject invention draws elements from Buckminster Fuller's concept for “World Game,” and from Meetup, Wikipedia, and Pokémon GO. World Game used a physical map, whereas the subject invention uses an evolving digital concept map or geographic map. Meetup uses online notification and signups to organize in-person meetings, whereas in the subject invention actions accomplished in the augmented reality environment prompt in-person “Flashlight Events” to launch a new focus or project. Wikipedia's distributed authors generally do not know each other. They select topics they want to work on. They work separately and independently on a collaborative result. Similarly, in the gameplay embodiment of the subject invention, the players select their topics of interest and are matched with others who have similar, or complementary, interests to form a team. Pokémon GO connected travel in the real world with creature-catching in augmented reality. One embodiment of the subject invention features an augmented reality overlay such that as a player travels the real world, his digital avatar “Guide” leads him on a map game board where task performance, knowledge platform building and actual contributions to the real world are substituted for creature-catching. The Intelligent Integrating System (ISS) tracks task performance, knowledge platform evolution, and contributions, tapping the collaborative intelligence of large groups, augmenting social networks where mobile devices support collaborative problem-solving by a large, diverse group of distributed humans and agents. The present invention supports a problem-solving ecosystem that can overcome the constraints of top-down, hierarchical management in conventional, consensus-driven problem-solving models. In the present invention one-to-one communication systems (telephone, mobile phone, email, and apps) are supplanted by mobile devices used as one-to-many requester systems and networking tools.

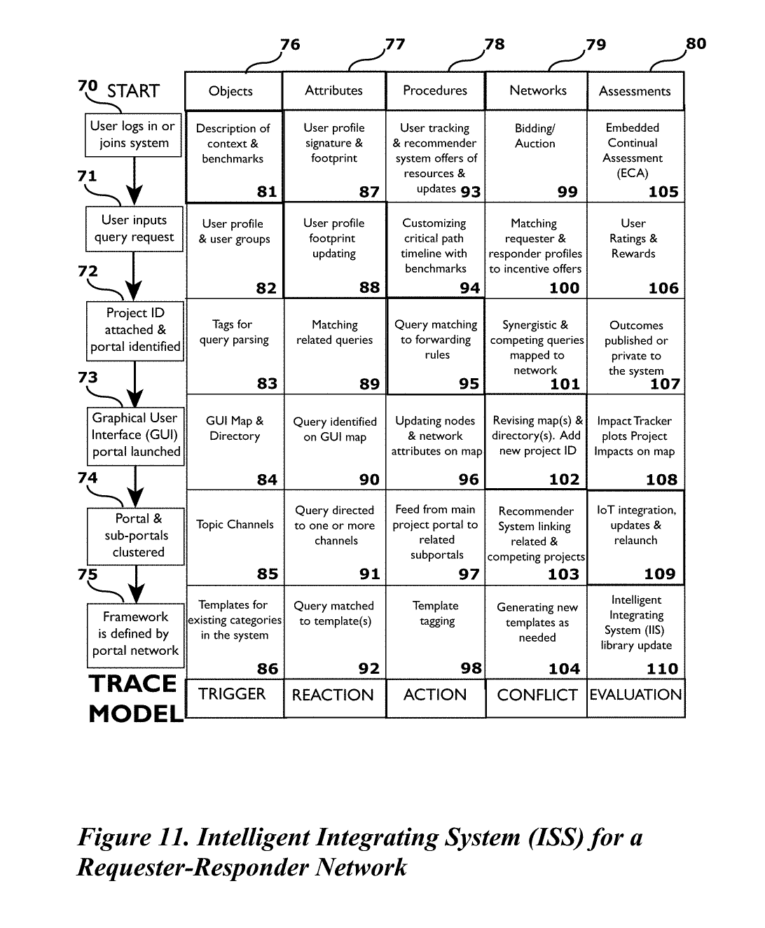

FIG. 11 shows the how, in one embodiment for a Requester-Responder network. In a preferred embodiment, a reconfigurable crowd-sourcing requester-responder system and knowledge platform to respond to requests or crowd-sourced challenges comprises a processor; a storage element coupled to the processor; encoded instructions; wherein when executed, the system is configured to: receive a request from a task requestor; tag said request into at least one of a category, group, sort, class, and, or sub-class; apply query-forwarding rule to forward the tagged request to at least one topic channel, wherein the tagged request is expert-sourced to at least one responder meeting the required credentials for a given request; track usage of requesters and responders by at least one of the following identifier tags: geographic-location data, timestamp data, topic tagging, and user profile; publish responder's entry for at least one of commenting, rating, and, or voting or maintaining anonymity of responder, as designated; and wherein usage causes an operational state change of at least one of the query, the query-forwarding rule, credentials, and, or a project requisite. Once a Requester joins or logs into the system 70, the Requester inputs a query or request 71. Note that both the Requester and the Responder are Users in this system. FIG. 11 focuses on the Requester. The system attaches a project ID to the query or request 72, opening the portal identified as the best match to the category of the query or request 73, and linking to sub-portals 74, other portals in the system, which could be the main portal for other queries, but are partial matches for this query or request and so are subordinate to the main portal 73. The system offers to the Requester a framework 75 to structure the Requester's data entered into the Intelligent Integrating System (IIS), which consists of objects 76, attributes 77, procedures 78, networks 79, and assessments 80 through which the Intelligent Integrating System (IIS) performs updates 110. This framework starts with the Requester's description of the query context and objectives 81, which adds to the Requester's existing profile in the system. The signature portion of the Requester's profile is entered by the Requester into the system. The footprint portion of the Requester's profile evolves through system use. The system recommends links for the Requester to closely matched user groups 82. The Requester's query is not only tagged by the Requester when entered into the system but the system also performs automated tagging, timestamping, and geo-locates the Requester. User and system tagging together support query parsing 83. The main portal is matched to the Requester's query, both by Requester selection and/or by automated matching, serving up a graphical user interface (GUI) with a backend directory 84, which includes topic channels 85 and templates for existing categories in the system 86. The Requester profile 87 consists of both a signature, entered into the system by the Requester, and updated with each new query, and a footprint, which tracks how the Requester uses the system 88. Queries are parsed and matched to related queries 89. Each public query is tagged on a concept map and by its geographic location on a map 90. The query is routed in the system, directed to one or more channels 91, and matched to one or more templates in the system 92. The above steps for matching, linking and clustering build a problem-solving framework for Procedures 78. User tracking enables the system to offer both Requesters and Responders recommendations of resources, updates, and opportunities 93, customizing critical path timeline with benchmarks 94, matching the query to forwarding rules 95, which update the nodes and network attributes on the map 96, feeding from the main project portal to related sub-portals 97, tagging templates associated with each query and linking tracking to associated tasks being tracked in the system 98. All user and system actions configure the networks of the Intelligent Integrating System 79, which may, in one embodiment, be represented as a graph database. Bidding by Responders in an auction produces well-matched responses to the Request 99. User profiles of both Requesters and Responders can be matched to incentive offers 100 to augment the attractiveness of a given bid. All users (both Requesters and Responders) have profiles. Each query launched or completed also has a project ID, with an attached profile, enabling synergistic or competing queries to be mapped to the network 101, such that maps and directories linked to each query can be revised as called for by the query/project profile 102. Mapping of a given project to the resources of the Intelligent Integrating System (IIS) enables the IIS to launch a recommender system linking related, synergistic and/or competing projects 103, and generating new templates as needed 104. The Assessment/Evaluation stage 80 of the TRACE cycle enables system updates that relaunch the cycle, with as many iterative problem-solving cycles as necessary. Embedded Continual Assessment (ECA) 105 comprises the total capacity of all actions in the system to receive and respond to continual impact tracking. User ratings and rewards 106 are attached to project outcomes, which may either be published or private to the system 107. The Impact Tracker plots all impacts to the map and back end database 108, although only published impacts are shown. The system triggers Internet of Things (IoT) system updates, as when a smart device alerts the Doctor Homecare Network 109. The Intelligent Integrating System (IIS) Library updates 110.

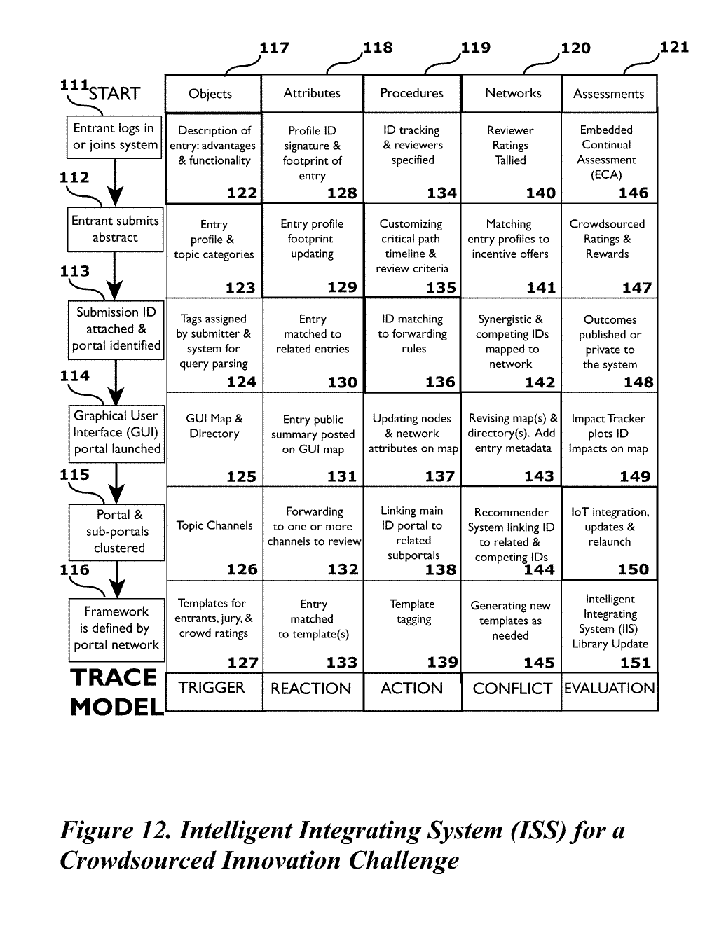

FIG. 12 shows how, in another embodiment, the Intelligent Integrating System (ISS) can be used to manage a grant proposal system or crowdsourced challenge/competition, which may have rolling or repeated submissions (hereafter called “entries”). In a preferred embodiment, a reconfigurable crowd-sourcing requester-responder system and knowledge platform to respond to requests or crowd-sourced challenges comprises a processor; a storage element coupled to the processor; encoded instructions; wherein when executed, the system is configured to: receive a request from a task requestor; tag said request into at least one of a category, group, sort, class, and, or sub-class; apply query-forwarding rule to forward the tagged request to at least one topic channel, wherein the tagged request is expert-sourced to at least one responder meeting the required credentials for a given request; track usage of requesters and responders by at least one of the following identifier tags: geographic-location data, timestamp data, topic tagging, and user profile; publish responder's entry for at least one of commenting, rating, and, or voting or maintaining anonymity of responder, as designated; the response comprised of a competition entry relative to a request for a proposal and, or competition challenge; whereby the competition entry is assigned a score, as per a bidding and, or auction rule, and the competition entry is linked to an incentive and, or reward system; and wherein usage causes an operational state change of at least one of the query, the query-forwarding rule, credentials, project requisite, bidding rule, auction rule, incentive system, and, or reward system. FIG. 12 clarifies how the system can accommodate both User Profile tagging and Entry Profile tagging. Although “linear competitions” (call for submissions, review of submissions, and awarding a prize) are widely used to attract talent to address innovation challenges and to crowdsource solutions to problems, what has been missing is the collaborative intelligence system offered in this patent such that crowdsourcing can move beyond the traditional formula of a single call and linear competition. What is needed is a system to support ongoing, rolling crowdsourcing around a given problem, with benchmarks to achieve, and incentives and rewards offered, capacity to cluster synergistic submission ideas on a knowledge platform, and capacity to track the impact of each innovation through time. FIG. 12 illustrates an embodiment that is triggered by a system broadcast to many potential Responders. For example, a granting agency or an organization managing a competition challenge, could broadcast a request for proposals (RFP), or competition challenge guidelines. A competition entrant can join or log into the system 111. The competition entrant submits an abstract 112. The system attaches a submission ID to the competition entry 113, opening the category portal identified as the best match to the category of the competition entry 114, linking and clustering sub-portals 115, other portals in the system that could be the main portal for other entries, but are partial matches for this entry, and so subordinate to the main portal 114. The main portal offers the competition entrant a framework 116 to structure the entrant's submission for the Intelligent Integrating System (IIS), which consists of objects 117, attributes 118, procedures 119, networks 120, and assessments 121 that enable the Intelligent Integrating System (IIS) to perform updates 151 and to cluster entries that are mutually synergistic. This framework starts with the competition entrant's description of the features and advantages of the competition entry 122, which defines the initial signature of the entry (the first component of the profile). The footprint (the second component of the profile) grows as the submission evolves in the system 128. The system recommends links to related topic categories 123. Each entry is not only tagged by the entrant when entered into the system but also receives additional automated tags from the system. All tagging supports entry parsing 124. The main portal is matched to the competitor's entry, either by user selection or by automated matching, serving up a graphical user interface (GUI) with a backend directory 125, which includes topic channels 126 and templates for entrants, reviewers (selected jury), and crowdsourced ratings of entries to the challenge 127. The submission profile 128 consists of both a signature entered into the system when the entry was submitted and assigned an ID, and a footprint, which tracks how the entry is rated by both the jury and crowdsourced assessments 129. Both entries and ratings are crowdsourced. Tagging is used to match related entries in the system 130. Each entry is tagged on a concept map and by geographic location of the entrant 131. The entry is routed both to best qualified reviewers (human) and to automated review 132. The entry is matched to one or more templates in the system 133. All preceding matching, linking and clustering builds a problem-solving framework for Procedures 119. Entry ID tracking and reviewer specification 134 supports customizing critical path timeline and review criteria 135, and matching the entry to forwarding rules 136 that update the nodes and network attributes on the map 137. The main portal for each entry is linked to related sub-portals 138. Templates associated with each unique competition entry are tagged to facilitate assessing the entry relative to the request for proposals or competition challenge 139. All user and system actions configure the networks 120 of the Intelligent Integrating System. Ratings of each entry are tallied 140, and entry profiles are matched to incentive offers 141 to augment an entry's potential for funding and implementation. All entries have summaries with attached profiles. Each entry has a submission ID, enabling synergistic or competing entries to be mapped to the network 142, such that maps and directories linked to the entry can be revised and metadata added as called for by the entry profile 143. Mapping each entry to the resources of the Intelligent Integrating System (IIS) enables the IIS to launch a recommender system matching related, synergistic and/or competing, crowdsourced entries 144, generating new templates as needed 104. The Assessment/Evaluation stage 121 of the TRACE cycle triggers system updates that relaunch another iterative cycle, with as many rounds as necessary for conclusion. Embedded Continual Assessment (ECA) 146 comprises the total capacity of each crowdsourced entry in the system to receive and respond to continual impact tracking. Crowdsourced ratings select entries for rewards 147. Depending on the guidelines of the competition or request for proposals, outcomes may either be published or private to the system 148. The Impact Tracker plots all entry IDs (whether visible or not) to the map and back end database 149, but only published impacts are shown. The system triggers Internet of Things (IoT) system updates as, for example, when a project on water conservation in agriculture, or marine acidity or pollution is monitored by a sensor network 150. All actions described above are logged and trigger Intelligent Integrating System (IIS) library updates 151.

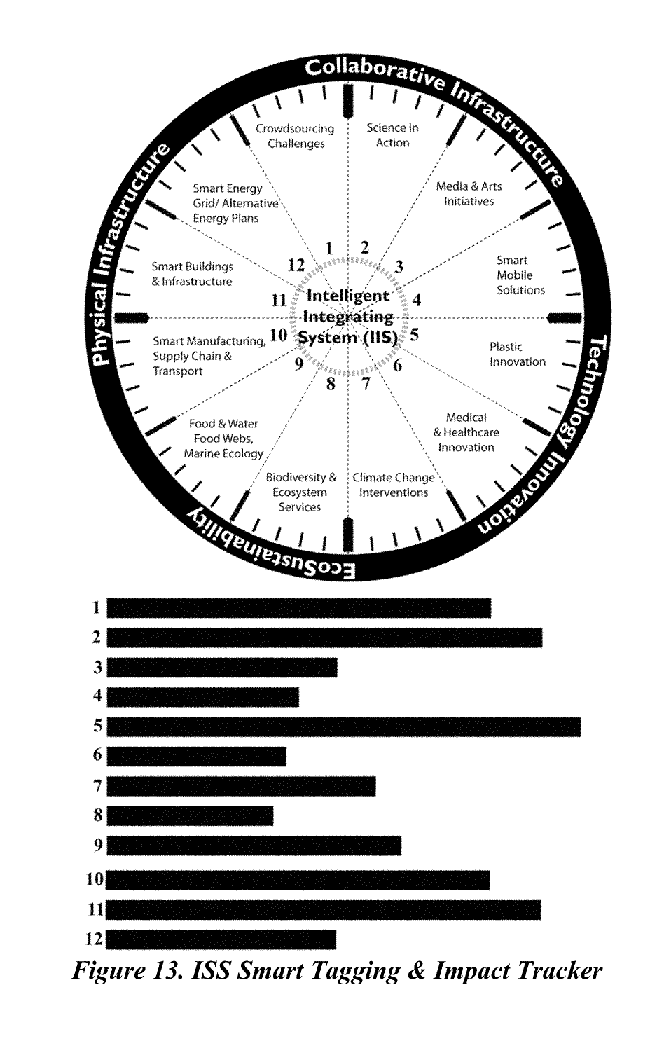

FIG. 13 shows the IIS Impact Tracker formatted using a circular “clock” user interface. This embodiment shows a system seeking and rating environmental sustainability innovations, though many user interfaces are possible, depending on the application domain. In this embodiment twelve categories are shown to illustrate possible user portals, but this example is not intended to limit the scope of the invention. A user who selects Plastic Innovation 5 as his primary category may also note that Media & Arts Initiatives 3, Smart Mobile Solutions 4, Medical & Healthcare Innovation 6, Climate Change Interventions 7, Biodiversity & Ecosystem Services 8, Food, Water & Food Webs 9, and Marine Ecology 10 are all subordinate portals. Category labels for the twelve wedges are examples and do not limit the names or number of categories that could be selected for Impact Tracking, nor restrict the design of the user interface to any particular format. In this case, twelve categories are represented, any of which can be a major portal, or sub-portal. As information is added to the ISS, one of these twelve main tags may be selected, or another tag may be added. Note that in FIG. 12 categories are equivalent to main portals. But sub-categories are not equivalent to sub-portals. Clicking into any of the categories shown can bring up sub-categories that lie behind the primary portal, and so are not shown. The system can zoom in to focus on a particular category and drill down for more detail. In contrast, any main portal can, for a different entry, be a sub-portal. In FIG. 11 and FIG. 12 an embedded continual assessment tool using Transaction Records 105 provide data about the success of each coordinated transaction or event in the system, how users participated, and their preferences.

FIG. 13 shows an example of a possible user interface to facilitate category selection for content tagging. This is one component of the system that manages and clusters content by applying a unique ID to every item, by generating a unique letter-number ID, similar to a serial number, for every item in the system and coupling that unique ID to class IDs for tag categories, such as those below, such that unique IDs can be clustered by class or complementarity in a range of ways and such that content organized by human users can be managed and served on demand by an automated system. Tags attached to an entry include, but are not limited to query or entry ID; author ID (whether the entry is public or private); benchmarks; category & sub-category designations; channel designations; competing project IDs; context descriptors; critical path timeline; directory tags; geo-location of author at submission, geo-tags for entry content; goal identifiers; impact tracker tags; incentives; key words; map IDs; matches made; metadata not included in other tags; portal designation; recommender system offers; resources; rewards; reviewer/jury comments; social networks; sub-portal designation(s); synergistic project IDs; tag collector IDs; template tag(s); entry time-stamping (entry time); progress time-stamping (benchmarks achieved); topic channels; user group IDs; user ratings; workflow tags. Tags added as the entry proceeds through the system include, but are not limited to: benchmarks achieved; benchmarks revised; critical path status; footprint tags; goals achieved; goals revised; networks joined; reviewer ratings; and resources tapped. Tags to author footprint include, but are not limited to: entry ID; entry tags above; networks joined; responses to recommender system; site usage time and click history. Each tag added is notated with a timestamp, enabling the Impact Tracker to track the critical path timeline and record benchmarks achieved and impact of work to date.

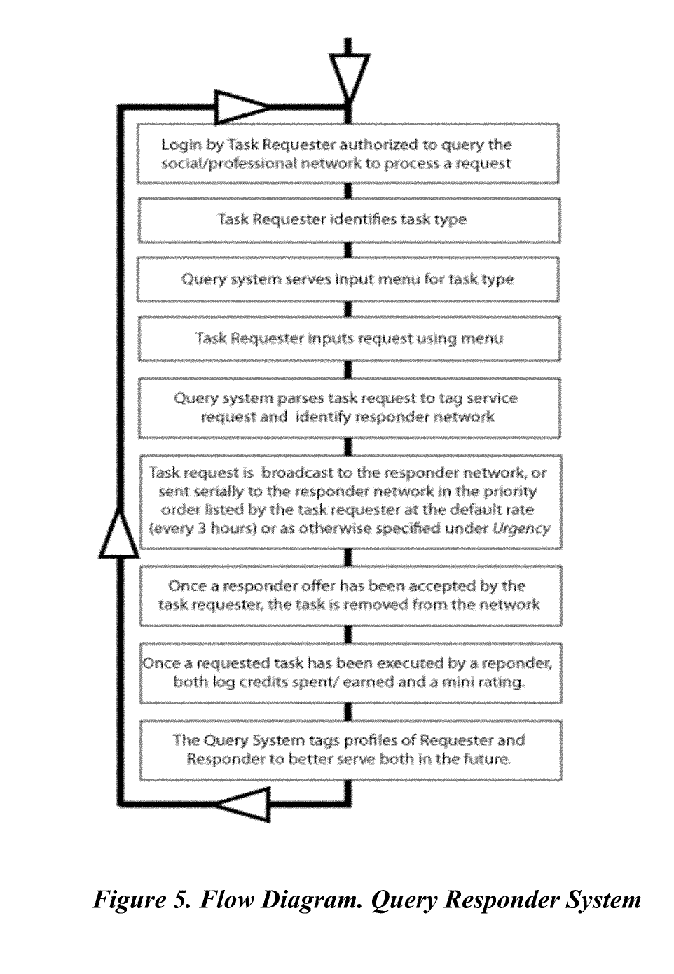

For tagging, the user uses natural language, clicking into a user interface, as shown in FIG. 13, to make tagging rapid and easy. Only the automated system sees the unique “serial number” signature and the growing “serial number” footprint that together comprise a machine-readable backend profile of every human, device, and knowledge entry in the system. The only ID the user sees is his own, which he chooses, and the ID name of his request, entry, or contribution in the system, which he also chooses. So, for example, suppose that an entrant responds to a crowdsourced competition challenge for plastic innovation and contributes an entry where the main portal is Plastic Innovation (FIG. 13-5). The initial signature of that entry could be DK2020 (the entrant's chosen ID)-Plastiglas (the entrant's chosen name for the entry)-060820203:07PM (submission date & time) P5plastic (main portal)-SP3media (Sub-portal)-SP4mobile-SP6health-SP7climate-SP8biodiv-SP9food&water.

The signature ID of the entry described in paragraph [0036] is a string: Dk2020-Plastiglas-060820203:07PM-P5plastic-SP3media-SP4mobile-SP6health-SP7climate-SP8biodiv-SP9food&water

Depending on the specific embodiment, and the amount of information included with the initial entry, there may be more components in the signature. The signature is timestamped on entry and is probably unique because of that timestamp. If it is not unique, a single number is added at the end, starting with 1, and counting up to the first number that makes the signature unique. The signature serves as a sufficient identifier for initial classification. The footprint is a growing string that is machine readable and shows the history of each entry in the system.

In one embodiment various automated procedures can be performed on queries and query responses including, but not limited to, statistical analysis, rating, tallying, grouping, tagging, linking to user profiles, aggregating, integrating, publishing for public comment, retaining as confidential etc. Query generators operate on data stored in any non-transitory terminal with computing capability and memory. Client software includes query analyzers able to receive, rate, cluster, search, tag and perform other operations on query responses.

A basic embodiment of the present invention serves a range of applications requiring coordination of large numbers of people, ranging from distributed project management involving a large number of diverse contributors to large events and crowdsourcing competitions wherein the Intelligent Operating System (IIS) operates in client-server mode: a Responder logs into a client and obtains a task request from a Requester (Flow diagram, FIG. 5). After performing the task, the Responder receives payment, experience, incentives, or reward points. Each advancement triggers new instructions from the In different embodiments of the invention, Requesters and Providers, or Guests and Guides, or other Senders and Receivers, can register, via the web or mobile devices, to contribute and receive instructions, clues, and information customized to their user profile, as defined not only by user-selected preferences, which comprise the User Signature, but also by the user's history of activity in the system, authorship role, and relation to others using the system, all records that co-define the User Footprint. When a Responder registers online to provide a product or service that can be optimized by comparing Responder profiles, the Responder is directed to set up a profile and preferences. Responders can log in, either via a custom website e.g. “My [service name]” or, for small service communities, via a unique service channel on a general website, established to serve the subject invention.

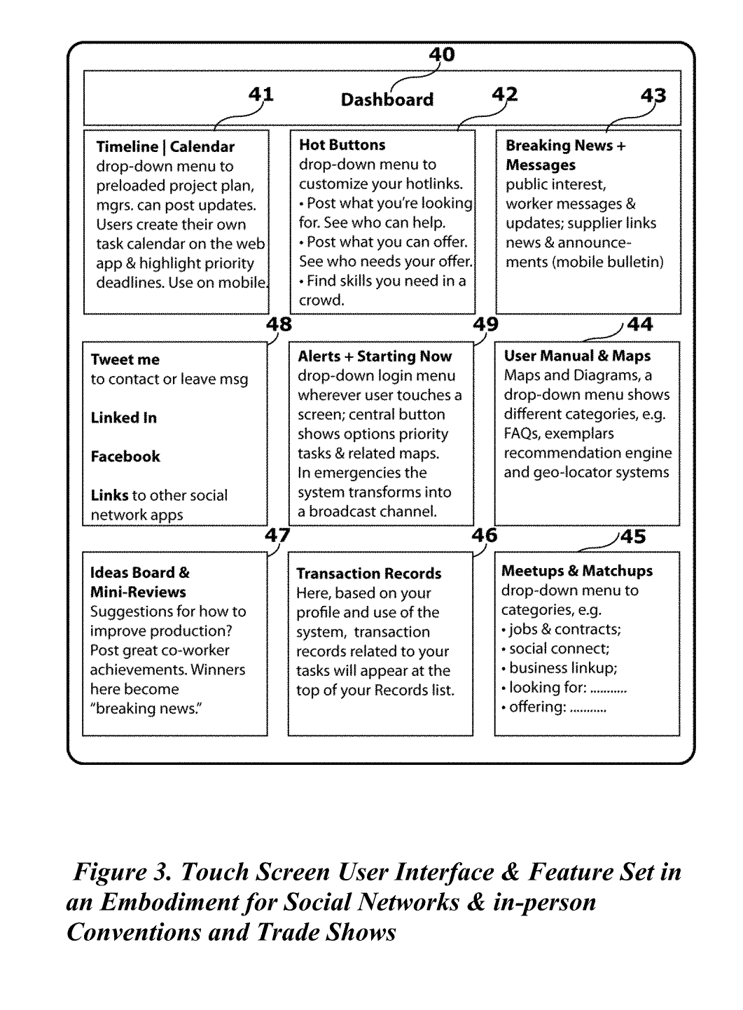

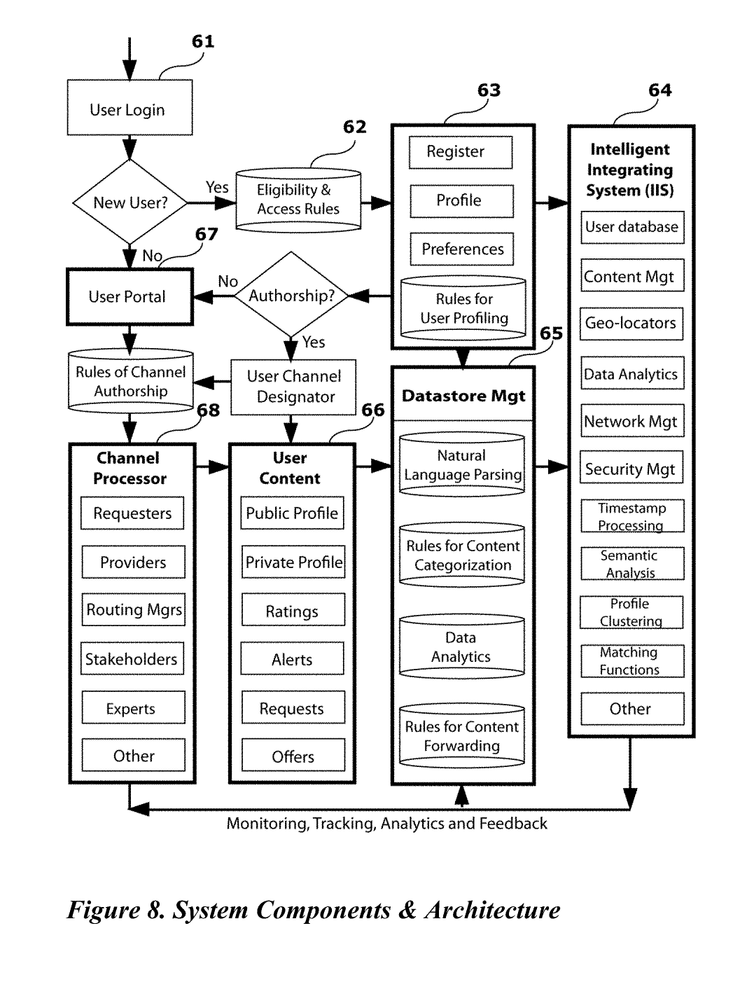

FIG. 8 shows the user setup sequence for an embodiment designed for large numbers of users participating in a distributed social network. The user first logs in 61. The system is automated to check eligibility and access rules 62. The user can set up a profile 63, including, but not limited to, email address, through which the system can determine whether he's approved to register or not. The email address serves as the user ID, first name, last name, company, position, mobile phone (automatically recorded if the user registers or logs in from a mobile phone), website(s), password, and preferences. The Taxonomy of User Profiles 63 evolves as users interact with each other. User preference options shown in FIG. 3 include, but are not limited to, Timeline/Calendar 41, for uses ranging from benchmark dates in project management to sessions that the user has chosen to attend at a conference or event. Alerts and Starting Now 49 show options selected by the user, or recommended by the Intelligent Integrating System. In one embodiment maps 44 relevant to the task request engage the user in a gamified parallel reality environment. Meetups (in person) & Matchups (online) 45, can either identify people who share similar user preferences (matched by similar profiles) or identify people recommended by the Intelligent Integrating System to respond to a given task request. Breaking News 43, may include alerts, clues in the interactive exchange embodiment, updates and other information; and Links 48 to complementary applications.

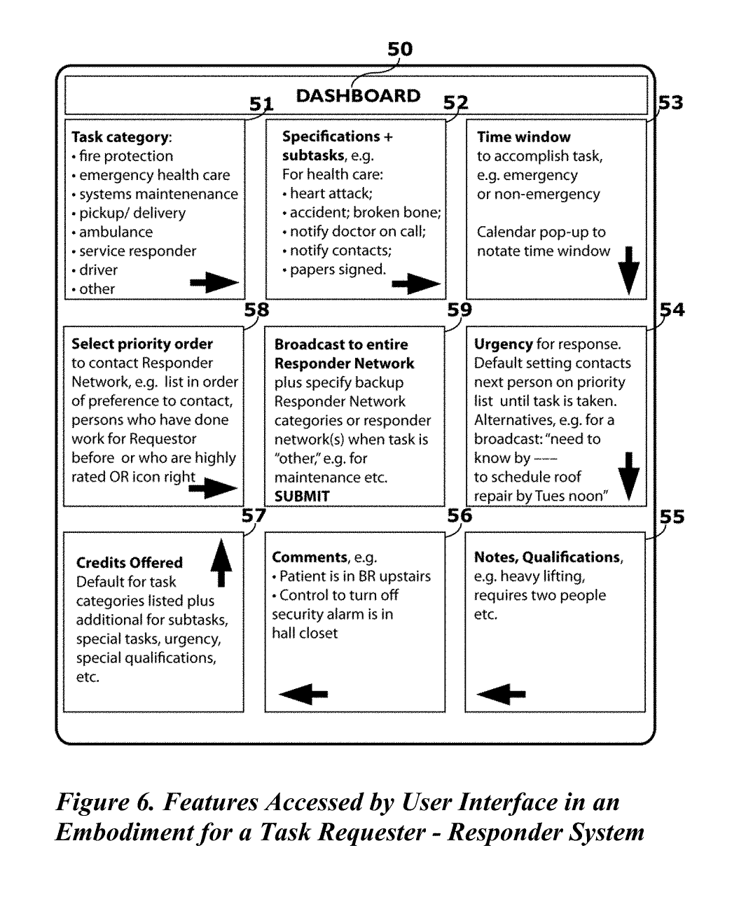

After the user registers by logging in and setting up a profile FIG. 8, a dashboard 63 such as shown in FIG. 3 or FIG. 6 is presented, accessing a menu list of setup items corresponding to the order of the buttons on the user interface, enabling the user to select task categories and pick tasks that he can respond to and schedule them in the Timeline/Calendar 41, which feeds to the “starting now” alert button 49, highlights a map of options selected 44, and allows him to select preferences for how priority alerts are received.

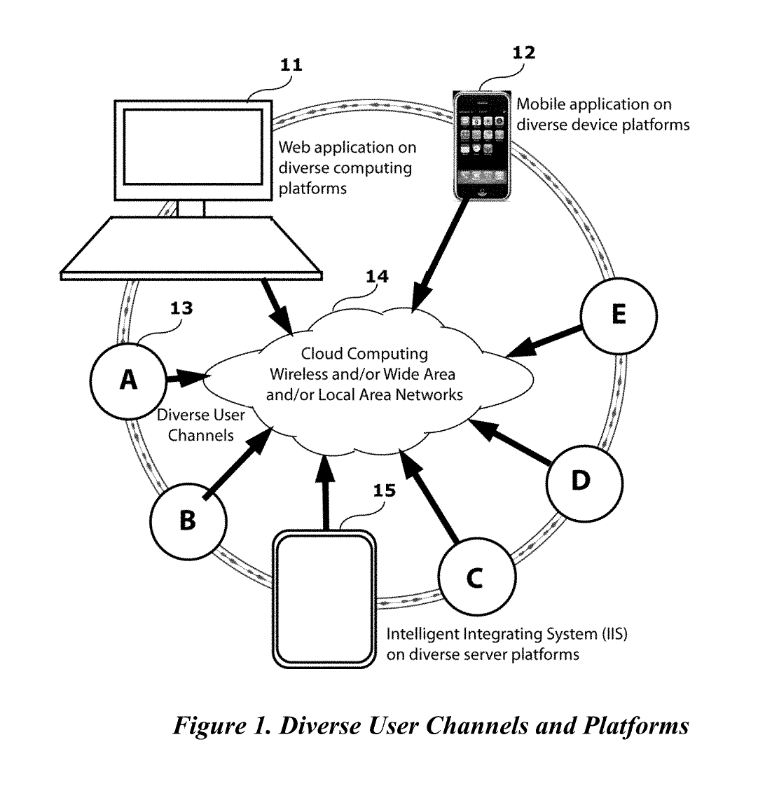

A basic embodiment of the present invention provides a means to coordinate large numbers of distributed participants, ranging from complex projects requiring many tasks executed by distributed performers with diverse skillsets, providing means to rate products and services via multiple channels for different categories of users, products, and services and parallel reality (online-offline) games. FIG. 1 shows one embodiment wherein an Intelligent Integrating System (IIS) comprises a database categorizing multiple channel feeds to the cloud 14, where channels serve diverse categories of users 13.

As shown in FIG. 2, the knowledge platform channels may include, but are not limited to, User Communities 18, Sponsors/Stakeholders 19, Producers/Providers 20, Requesters/Receivers 21, Supply Chain Managers 22, Domain Experts 23. These different communities have different levels of access, permissions, and rights of authorship. The IIS tracks and records usage by ID, geographic-locators, timestamps, category of user, user profile, and the network of links to user actions in the system, whether this IIS functionality is applied to in-person or to online or asynchronous exchanges or transactions.

In one embodiment the subject invention can be implemented as a parallel reality game where real players and augmented reality avatars interact. In one embodiment, the avatar of a more advanced player is assigned as a guide for a less advanced player; the avatar of that less advanced player guides a newer initiate. The Intelligent Integrating System matches avatar guides to players based on the profiles and experience level of both and sends Code Alerts to prompt the next steps of gameplay. An evolving infographic online game board uses both geographical maps to track locations and concept maps to track topical connections, allowing players to track the progress of collaboration as they co-develop a knowledge platform for sharing accomplishments achieved in the game, much as Wikipedia editors co-develop articles. Accomplishments may include, but are not limited to, micro-learning modules developed in part through meetup-style “flashlight events,” community service tasks and ecosystem preservation initiatives. It can be easily understood by anyone skilled in the art that the subject invention can serve diverse broadcast/comment, request/response applications including, but not limited to the gameplay embodiment, learning and training, environmental remediation and disaster response, and other requester-responder networks.

A user may belong to more than one category but can participate in only one category at a time. In one embodiment, levels of participation are coded according to the belt system developed for modern judo, now adopted by other martial arts, including taekwondo and karate, where the beginner starts with a white belt, progressing through yellow, orange, green, blue, purple, brown, red, finally to the black belt of a master, such that, in addition to contributor categories, users rise through the system and, as in martial arts, each level is designated by a colored belt. The actions taken in the system are recorded with color-coded tags or icons that correspond to each contributor's belt level. Belt levels run from White Belt (new Guest, novice) to Yellow Belt (Guest) to Orange Belt (newly-initiated Guide), Green Belt, Blue Belt, Purple Belt, Brown Belt, Red Belt, and Black Belt. As players achieve higher belt levels, they retain all access and entitlements of lower level belts and can continue to perform the actions that they were able to perform at lower belt levels. The game presents difficult missions and challenges where accomplishment can he rewarded in a range of ways, including, but not limited to, virtual currency, credits, incentives, and advancing to new status in the system, such as from Red Belt to Black Belt.

The functions described above, comprise one embodiment for a multi-channel Intelligent Integrating System with capacity to grow and evolve through use as users post recommendations to others. In one gamified embodiment, participants (e.g. Guests or Guides) post their recommendations in response to automated queries and instructions from the Intelligent Integrating System, generated in response to the user's profile, including but not limited to, the user's belt level, profile, location, actions already recorded in the system in that region, and multiple criteria about tasks that need to be performed, including but not limited to, regional priorities identified, regional organizations participating in a given quest, enablers identified and so on. In a project management application, channels include pre-loaded and on-the-fly external content feed 28, input from the user communities 18, sponsors/stakeholders 19, producers/providers 20, requesters/reviewers 21, supply chain managers 22, domain experts 23, and other stakeholders. Optional augmented functions include External Content Feeds 28, Links to other Tools and Applications 29, Automated Systems 30, with potential for the system database and its members to be translated to other Mirror Networks 31. In some applications, channels include pre-loaded and on-the-fly content from the host, which may include “Alerts” 49, “Breaking News” 43, or matches 45.

The subject invention can track task performance, community consultation, expert assessment or, in another embodiment, who went where, how long they stayed, and which products, services, knowledge, or opportunities were of interest to them, enhancing its capacity to serve as a recommender system. The Intelligent Integrating System serves all users, enabling them to see rapidly what's available, who's where, to receive alerts about opportunities and deadlines, and to set preferences for alerts and other notifications. This embodiment of the present invention is an interactive system, providing multiple channels for diverse user communities 18 and external content feeds 28, enabling stakeholders 19, Providers 20, and Requesters 21 to find what they need and to better contribute to and benefit from contributing to a given task or “gameplay.” The two basic roles of the system, Requester and Responder, are implemented with different subcategories and levels of access. For example, a Requester is one category of User; a Sponsor is another; a service Responder is a third. In one gamified embodiment nine belt levels constitute different provider categories, an internal evolving social network that grows by inviting more guests from the external community to share the experience and grow the community.

In the embodiment shown in FIG. 3, when the user clicks Calendar setup 41, he is presented with the option to create his own work schedule or calendar, using his computer or mobile device. The Calendar|Events button 41 connects users to relevant information, either requested or automatically matched by profile. Different categories of users are able to post tasks and events to an event calendar, including, but not limited to, location, date, time, host, and comments. The user interface includes the functionality of Hot Buttons 42, which the user can customize into personal hotlinks. Breaking News and Messages 43 offers a scroll or dropdown menu where news, alerts, instructions from the IIS, domain experts, Guides in the game or project managers, and other important notices can be posted as work progresses. Users receive postings, prioritized according to their explicit, stated preferences and implicit preferences, defined through previous use of the system. Hot Buttons 42, connects to offers and may have a scroll or dropdown menu where users can download maps and highlight their points of interest. The Meetups and Matchups Button 45 can include a dropdown menu wherein users can, through multiple choice questions and/or short text messages, create their personalized profile signature to receive recommendations of whom to meet, virtually or in person, wherever the system of the subject invention is being used.

In the embodiment shown in FIG. 3, a Launch Alerts Button 49 provides a place for sponsor notifications. For example, in one embodiment sponsors are selected by Green Belt Guides for “limelight” status because of their work for good cause. The Launch Alerts Button 49 enables Users to gain an overview of events, demos, launches, and other incentives, rewards, or special offers. Selections listed in a users' preferences appear at the top of their launch alerts lists. Sponsors can post their messages, customized for receipt according to user profiles and stated preferences. A Rate and Review Button 47 enables users to rate and recommend their favorites. Items most recommended are forwarded to Breaking News 43. Competition opportunities may also be posted as Alerts or “Hot Buttons” 42. FIG. 6 shows another embodiment wherein the system offers the user capacity to post a query or request 51 (as a Requester), and to respond, specifying what he can offer (as a Provider). In one embodiment this function can be used by project managers to identify capable talent or by employers to post job notices. Users can, through multiple choice questions and/or short text messages, create their personalized profile signature for recommendations of whom to meet virtually or in person wherever the subject invention is being used.

In FIG. 3 Links Button 48 enables users to link to other Apps and Social Networks, and to import contacts and other content and integrate complementary feature sets into a single system, recorded in the database of the Intelligent Integrating System (IIS). Notifications can be distributed to different user categories, as determined by user profiles, comprising signatures and footprints. Links may include alerts to profile-relevant opportunities, organizer and sponsor functions. In one embodiment, links to Notifications can include categories, such as jobs, hires, tech launches etc. Alerts to profile-relevant opportunities connect Producer/Provider 20 and Sponsor/Stakeholder 19 functions, enabling Producer/Providers 20 to update their offerings.

In FIG. 2 a range of Sponsors/Stakeholders 19 can provide pre-loaded rich content 28 to a Knowledge Platform Serving and Receiving from Diverse Devices 27. An embodiment customized for localized events, shown in FIG. 3 includes content from sponsors 43, the hosting city 44, and social networks 45. New content can be added on-the fly, in real time, from multiple channels. The Breaking News button 43 connects to the news network channels. The launch alerts button 49 links to a related suite of technology tools, which complement the subject invention.

The above basic embodiment, once implemented, can be adapted to serve a range of applications, based on the multi-channel, contributor-receiver model, such as
Disaster response following a hurricane, earthquake, or other catastrophe,
Health and clinic network response and elder homecare emergencies,
Networked learning initiatives, group projects, monitoring student progress,
Distributed collaboration and teamwork, onsite/offsite/diverse locations.
Mixed reality game network, addressing real problems in a parallel reality game using a map-based graphical user interface for the online gameboard and augmented reality game elements.

FIGS. 5 and 6 show a second embodiment of the present invention to address easily specified tasks, including, but not limited to task allocation as in hiring local talent to perform work, where a Task Requester specifies the task, and Task Responders offer to perform the task. A similar distributed system could also be used for the distributed coordination of activities, announcements, classes, delivery, events, doctor home visits, interest groups, rideshare, volunteer opportunities, where the Task Requester specifies the task, and Task Responders offer to perform the task. Login by a Task Requester brings up that user's profile with associated categories and tags. Each Task Request is also annotated with categories and tags. Initiating a Task Request triggers updating of both the Requester profile and Task database, triggering the IIS to serve an automated query menu, which enables the Task Requester to format his request so that it can easily be processed by the Intelligent Integrating System. The task is parsed and analyzed for response by a recommender system. The Task Request is then allocated to Responders based on pattern-matching to related Task Requests and to Responder Profiles. Once assigned to a Responder, the Task is recategorized to “Processing” and allocated to a critical path timeline, which triggers the functions of Critical Path Tracking and Embedded Continual Assessment. Once the Task is completed, it is subject to Assessment and Integration into the Intelligent Integrating System's Knowledge Platform of Task Results. In a parallel reality gamified embodiment, at the start of each interval of the game, the Intelligent Integrating System generates requests to all players in the game, who generate invitations to their networks outside the game to join as Guests, bringing new blood and ideas into gameplay.

This second embodiment of the invention could also be used, as shown in FIG. 6, as a method for Task Requesters and Task Responders to participate in a distributed service network wherein the User first logs in with an ID and password. Users can be both Task Requesters and Task Responders, although some may use the system primarily, or exclusively, in one mode or the other. Everyone in the system has credits, either as a result of performing work that earns credits, or as a result of buying credits or virtual currency to spend in the virtual ecosystem. Those who use the system only as Task Requesters gain credits by purchasing them, while those who use the System both as Task Requesters and as Service Providers, can exchange their products or services within the system for credits, which they can then spend to purchase other goods and services, or translate into cash payments periodically. A Task Requester pays in credits, transferred from his account to the account of the Task Responder. If the Task Requester has insufficient credits when he requests his next task, the system will remind him to refill his account. In the gamified embodiment sponsor funding provides prizes, both to those whose overall gameplay earns the most points, rewards, and also to specified winners of specific challenges launched in the game environment.

A third embodiment and cluster of applications applies the present invention to enable community members to address distributed community applications, such as safety and security (police protection), fire protection, transport (e.g. share-a-ride, bus, train, plane schedules), travel accommodation and other needs, commodity availability, searchable in various ways, e.g. by commodity, costs, home and office rentals, locations, need, services, time of availability, store hours, real estate for sale. Commodities can also be offered as rewards in the gamified ecosystem.

A fourth, embodiment of the present invention addresses tasks requiring cross-disciplinary expertise, such as sustainable remediation and disaster relief, where a coordinated systemic response requires knowing who can supply what, when, and where, and who needs what, when, and where. This fourth cluster of applications supports a range of tracking and logistics functions, such as supply chain tracking, networked systems tracking, carbon footprint tracking, water tracking, and so on, applying, with some modifications, the backend developed for the first, second, and third applications above. Augmenting traditional methods of problem-tracking, the subject invention can cross-reference user actions within the system. This fourth embodiment has the option for gamification, granting points, incentives, and rewards for work well done.

In applications, such as disaster relief or sustainable remediation, Task Requesters can instantly shift to become Responders and vice versa. The system enables rapid exchange of information from one to some or many, some to some or many, many to many, geographically locating items, people, tasks, and resources being tracked by Task Requesters and Responders, time-stamping Requests when submitted and Responses when committed (start time) and completed (end time), structuring and organizing problem-solving status updates to enable collaboration in unpredicted circumstances. The geographical locator stamping, and tagging of user entries and responses, allows the Intelligent Integrating System (IIS) to perform geographic analysis of user needs and resources, and capabilities to meet those needs, by categorizing Requests by neighborhood, city, region, or other geographically defined category in order to cluster responses by location and other relevance factors, as well as to perform profile analysis of users and comparative clustering across geographic categories with similar challenges and attributes where geographically specified sub-routines can be specified by task requesters to the query system running in a defined region.

The present invention enables greater efficiency in addressing tasks within a geo-proximal community, or in complex situations, which require rapid response on the fly, in real time, as in emergencies where traditional systems break down or prove inadequate. Problem mapping tracks process steps, which users may follow serially, in pre-specified or specified-on-the-fly sequence, or in user-selected order as circumstances require. Task order of execution is logged using an alpha-numeric interface, e.g. on a mobile phone or computer keypad, or a clickable or touch-screen graphical user interface. Distributed agents (human or not) gather, share information and collaborate to respond to problems posted as Task Requests. Geo-proximal capacity to specify and log tasks applies both to project management and to the gamified embodiment.

Collaborative problem-solving by a distributed, cross-disciplinary human-agent social network entails pattern recognition, classification, and routing of tasks to the appropriate Responders, and/or automated discovery and dynamic integration by an Intelligent Integrating System (IIS) of distributed input crowdsourced from autonomous agents and human users. The IIS presents prompts that elicit human judgment in response. The IIS sorts entries into multiple categories, serving profile-responsive queries, tracking responses, performing aggregation and providing status updates, as well as continually updating information and task progress analysis, sharing status updates at different stages of a collaborative problem-solving process. The IIS integrates data gathered from task performance, which can be automated for some functions, or support human computer interaction for others. The IIS tracks progress, archiving searchable process records and statistics. IIS services, processing functions, query systems, and integrator functions are core processes serving its distributed network.

The coding of data enables data representation and data integration, which could comprise any or all of the following methods of classifying query responses received based upon: steps of query intake through an alphanumeric keyboard or graphical user interface; time-stamps and geographic locators, subject matter and context-coded natural language classifications and tags; mapping relationships, archiving relationship maps, relationships to include data overlap and co-dependencies, user relationships and networks, critical path task networks, and so on, in a computer readable storage device so that they can be accessed from multiple nodes and retrieved in various ways; and updating responder profiles based upon query responses received from each responder.

The subject invention can be designed, where desirable, to have a game-like look and feel, and to apply traditional game techniques to motivate participation: points, prizes, levels, rewards, pingbacks, coupons, clues, tokens as components that can be selectively embedded into the system. Translating game-like attributes into the system motivates participation in the social network's tasks that require problem-solving, enhancing its service, and such game components can also be applied in performance evaluation. Credit points can be converted into prizes and/or into virtual currency to spend in the ecosystem. A responder's contribution and expertise can be classified by type and rated for quality, using existing click-streaming technology. As in online or mobile games, contributors advance to higher levels of participation based on their level of expertise and achievements in the game environment and the value of their contribution, which can, in one embodiment, be measured through a credit points reward system wherein contributors are paid, or otherwise rewarded by credit points earned. In one embodiment, first round contributions, and each subsequent round of entries, serves as the basis for automated generation of future queries based upon previous query responses, comprising the steps of retrieving query responses from an individual agent or from one or more groups of agents; segmenting the response into key phrases; scanning each phrase for patterns already in a pattern library and for new patterns that need to be archived; and producing a query generator for each query response grouping found, or selecting a query generator from among those that respond to similar response profiles.

In one embodiment of the invention user profiles can be augmented through credits, exchanges, rewards, ratings and embedded continual assessment, responding to individual and changing program needs. Extending social networks, this system can also serve as a professional network where each user can invite co-workers to join. In one embodiment, as in pyramid models, contributors' total credit points are the summation, not only of their own credits, but a pre-selected % of the credit points of those they have directly engaged in setting records and task performance as a whole and smaller % of those downstream from their direct invitee list, such that credit points of service providers may be translated to virtual currency or cash bonuses at defined payment intervals.

The subject invention provides for different levels of authorship, permissions, content filtering and access. Entitlement permissions are adjustable as the problem-solving process requires, ranging from confidential and anonymous to readable, open for comment, permission to edit, anonymous or credited to the contributor. Ratings or reward points may accrue to highly rated contributors. Categories of permissions, and means of granting permissions can be revised. In one gamified embodiment, levels of access and entitlement permissions change as the new entrant (white belt) progresses to novice (yellow belt) and on through the seven levels of Guides to Black Belt.

In one embodiment of the present invention the Intelligent Integrating System dynamically distributes tasks from Task Requesters with diverse needs to Task Responders with different skills. Each Task Request is time-stamped, geo-located and logged into the IIS knowledge processor, which tracks tasks accepted and performed, and logs performance ratings. User profiles, credits, and credibility evolve as use of the system invokes continual user profile and status updates. The system issues, and efficiently responds to, Task Requests. Task Requesters submit requests. Task Responders survey requests (sorted by time, type, geographic location etc.), prioritize and respond to those tasks they can most effectively perform, which facilitates project management. Through a credit exchange network, Responders earn credits for tasks performed, and Requesters pay for tasks.

The Task Requester-Responder embodiment is applicable across a broad spectrum from adventure tasks in a gamified embodiment to utilitarian tasks, such as contractor tasks. The present invention enables more efficient delivery of a range of consumer products and services. In particular, the present invention enables sole proprietors and small business owners to participate in a distributed network able to deliver service advantages equivalent to those of larger companies—rapid response time, diversity of expertise, and capacity to track data or user profiles, as they evolve through use of the system.

Once logged in, the User chooses between two roles, in one generic embodiment consisting of:
1. Task Requester
2. Task Responder (Service Provider)

In other embodiments these contributor and receiver roles can include project manager and contractor, organizer and participant, health care provider and patient, teacher and student, and so on. If at the Welcome Screen the user chooses Task Requester, he'll see credits remaining in his account and be able to click to see costs of various tasks he can request. A text box allows him to propose a task not on the list and propose a fee (payable in credit units) for that task, subject to approval.

It is an object of the present invention to enable collaborative problem solving, wherein a data processing network, the Intelligent Integrating System (IIS),
maintains individual responses private/anonymous, or makes them visible/credited, as specified by the task requester or by each participant;
provides regular updates of the globally integrated response status, visible to the social network as needed;
receives and parses natural language comments from responders independently of each other when responders should not be influenced by others' responses;
publishes selected responses for discussion, rating or vote from a large, distributed group of user-responders when an iterative process, such as the Delphi method of repeated polling, is useful to achieve convergence; and
queries distributed agents and/or clients;
receives and integrates their responses, and
generates new queries based upon Task Requester needs. User performance capability is defined by assessments, tagged to user profiles.

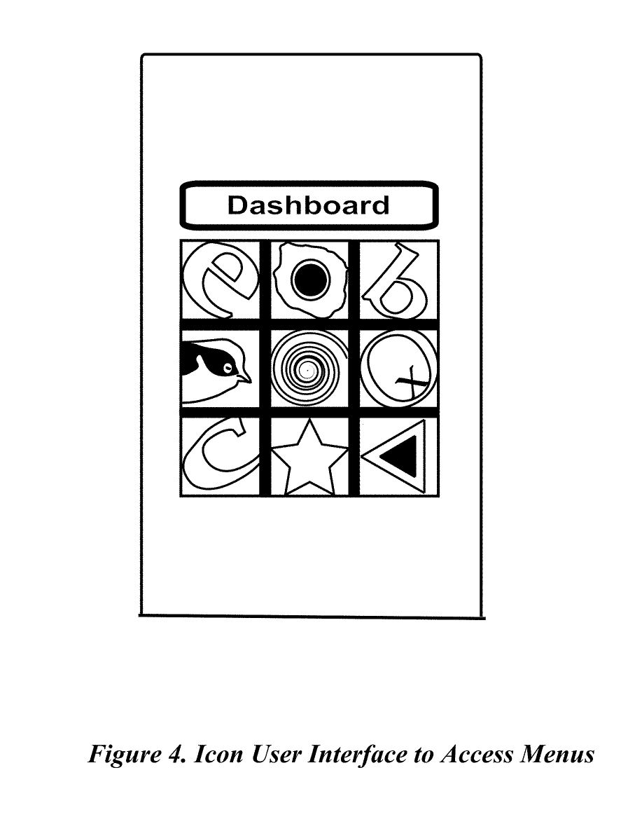

FIG. 4 represents a graphical user interface (GUI) of a Knowledge Navigation Map with response categories that can evolve as a navigable content map. In one embodiment of the present invention, the query system on a mobile phone or other device has a touch screen user interface with nine icons, arranged like a tic-tac-toe board, enabling the user to follow a multi-step process sequentially, in an order that is pre-specified, specified on-the-fly, or in a user-selected order, repeating steps as necessary, depending on the task, which can include wiki collaboration. How it is used to navigate is recorded, adding to the footprint of the User Profile and enabling evolution of the Intelligent Integrating System.

In one embodiment, when a User logs in for the first time, he's prompted to enter basic profile information. Since he won't have performed any services to date, he acquires credits through setting up an account. He must click to agree to the network rules: default charges for specified tasks, conditions when special additional charges are permitted etc. After enrollment, the user can set up capacity to automate a request in the network. A Task Requester can enroll as a Task Requester without enrolling as a Task Responder. Note that a Task Requester can set up in advance a medical alert request (or a relative can set up this alert on behalf of an elder person) such that in the event of an emergency, the Requester need only press the screen, and the request is automated. The setup uses a touch screen user interface as in FIG. 6:
1) Starting in the upper left icon 51 in FIG. 6, to set up the Task Requester choose a task, e.g. “emergency health care.”
2) Moving to the right, to the upper middle icon and scroll or pull-down menu 52, specifies task and subtasks, e.g. “fall, maybe broken bone” and “need X-ray.”
3) Moving right to the upper right-hand icon and pull-down menu 53, one selects the Time Frame, as soon as possible today.
4) Continuing clockwise down to the right-hand middle icon and scroll or pull-down menu 54, the system can be pre-specified as high urgency, that the Requester is alone and needs an ambulance.
5) Continuing clockwise to the right-hand bottom icon and scroll or pull-down menu 55, labeled Notes, he posts need for strong men to lift a very heavy patient.
6) Continuing clockwise to the middle bottom icon and scroll or pull-down menu 56, he adds Comments, special instructions not covered elsewhere.
7) Continuing clockwise to the left-hand bottom icon and scroll or pull-down menu 57, he notes medical advice.
8) Continuing clockwise to the left-hand middle icon and scroll or pull-down menu 58, he specifies preferences.
9) Once the system is set up, a caretaker or user only needs to press anywhere on the screen to activate the center middle icon 59, which “Submits” to the Emergency Responder Network.

If manual use, rather than preset automated use, is selected, each icon, when clicked, opens to a window with a multiple choice list, plus the alternative, “other,” which opens a text box. Upon responding to all nine icons, the system prompts, “Ready to submit?” If the Responder clicks, “Yes, submit,” his request is tagged, time-stamped and sent to appropriate network(s). If he responds, “Hold revise,” he can revisit any or all of the nine icons to revise his request before submitting. FIG. 6 shows one embodiment with a clockwise structure of the graphical user interface.

If at the Welcome Screen the User chooses “Task Responder,” rather than “Task Requester” on his first login, he'll be prompted to enter basic information, office location, phone numbers, and service provider category. He clicks to agree to the network rules, which may include, but are not limited to, default charges for specified tasks, conditions when special additional charges are permitted etc.

In one embodiment, after a one-time only registration on the Medical Responder or Homecare Network, the doctor sees a touch screen system:
1) Starting with the upper left icon 51 in FIG. 6, the Doctor (Task Responder), who has already been vetted by the system as a qualified Responder, chooses a task, e.g. “doctor home visit,” sees a list of Task Requests, and clicks on a Task Request s/he is responding to.
2) Moving to the right, to the upper middle icon 52, he sees the address of the task request, the type of task request, “fall” at (location), and a clickable map with directions to the home, and task specifics, and a link to the patent's online medical history, to which the patient has given doctors in the system access.
3) Moving right to the upper right-hand icon 53, s/he sees the time the Task Request was submitted. In the case of a medical emergency the response time starts when the request was submitted. In the case of interviewing for an on-call medical professional, the Requester specifies a time window for interviews and deadline to complete.
4) Continuing clockwise down to the middle right-hand icon 54, which specifies high urgency level, s/he responds, saying when s/he can be at the task location. The earliest qualified response is assigned.
5) Continuing clockwise down to the bottom right-hand icon 55 s/he reads Notes and Details: Suppose that the Request is for a Doctor who can be on call for potential future emergencies. In that case, the Task Requester may want an interview first to discuss the task (or phone interviews with several candidates first). S/he also notes listed qualifications that might preclude a doctor from performing the task, e.g. availability for weekly consultation with the patient's daughter on Thursday at 5 PM.
6) Continuing clockwise to the middle bottom icon 56, Comments, he texts that he is seeing a patient at a nearby location, which may run overtime so after 5 PM is best.
7) Continuing clockwise to the left-hand bottom icon 57, he accepts the terms: default credits for the doctors' network and approves after hours rates at 1.5 default rate, saying that he can come to the patient's home between 5 and 9 PM if preferred. He clicks “agree.”
8) Continuing clockwise up to the left-hand middle icon 58, the Doctor/Responder prioritizes, dragging and dropping to reorder the Patient Home Visit Requests s/he has agreed to respond to and decides to retain (or not retain) any other requests for future response.
9) S/he ends at the final, Center middle icon 59, having decided which of the house calls on the middle screen to accept first. S/he can accept only one house call in a given time window. When s/he accepts that house call within the urgency window, it is automatically removed from all other doctors' option screens. S/he proceeds to the home to visit this patient. Other tasks he prioritized and retained to the option screen (middle icon) remain there, unless taken by other doctors. In this embodiment the Impact Tracker tracks patient condition at each house call.

In another embodiment the Impact Tracker serves a crowdsourcing application domain, managing competitions to crowdsource innovative solutions and diverse expertise to address a given problem. The query or Request is broadcast from the system to many Responders, whose responses to the Query, or competition challenge, are processed through the Intelligent Integrating System (IIS) as shown in FIG. 11 and described in Paragraph [0071].

The system automatically removes tasks as they are taken and also blocks Task Responders from taking tasks if the Task Requester has specified: “Call Task Requester” before accepting task. This allows the Task Requester to interview several candidates before deciding which contractor to hire. The level of automation can be customized, enabling the present invention to be used where personal contact is required prior to task acceptance by the service provider.

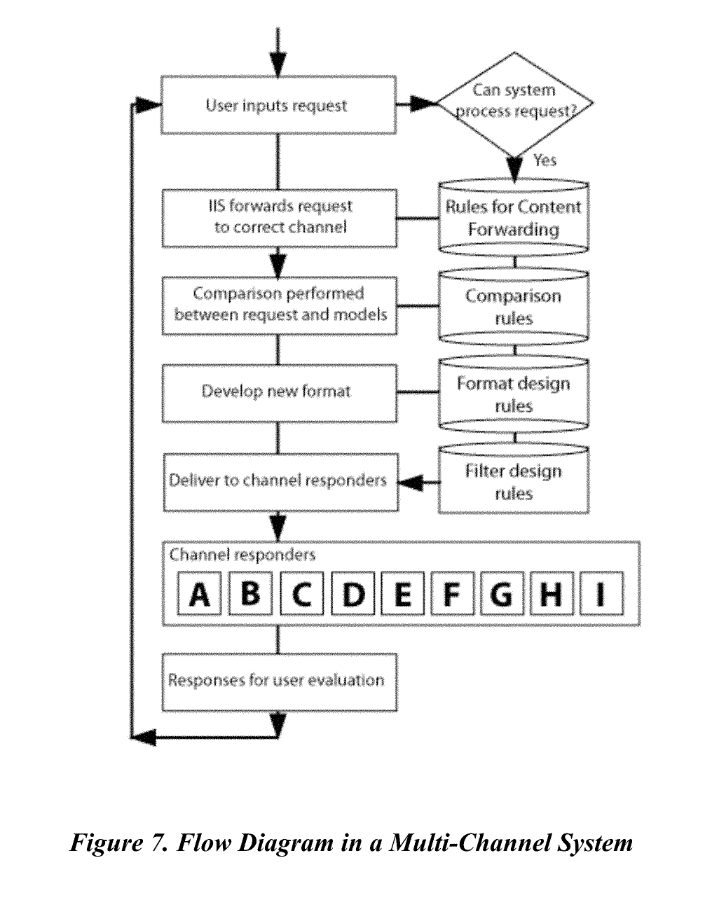

FIG. 7 shows how the system handles a generic user request, determining first whether the system can process the request or not, and, if yes, thereafter applying a series of matching algorithms and forwarding rules to process the request and deliver it to the appropriate channel responder(s).

FIG. 8 shows the system architecture where users log in 61 to a system comprising both public access and multiple levels of privacy, depending upon user category and role in the system, as determined by Eligibility & Access Rules 62. New users must register, fill out a profile and select preferences 63. This information is their initial signature, which is used to determine how the system will receive content from and deliver content to them. Users have different levels of authorship, determined by a user channel designator 66. They contribute content of different types and receive content via a channel processor 68, according to their profiles, category of use, preferences, and past history of using the Intelligent Integrating System 64. User content is managed by a data store management system 55, that feeds into the Intelligent Integrating System 64, which processes data such that users can receive customized information according to their explicit and implicit preferences 63.

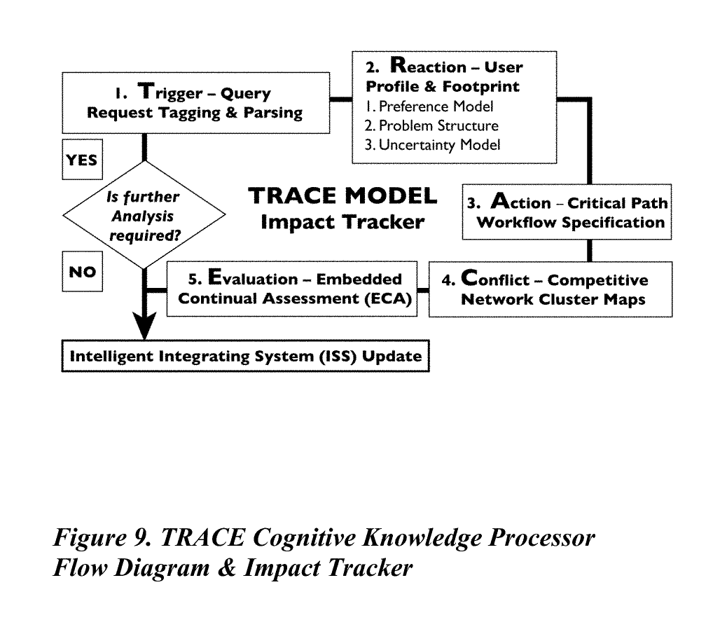

FIG. 9 shows a simplified flow diagram of the TRACE Cognitive Knowledge Processor and Impact Tracker, whose operating components are explained in detail in FIG. 11 and Paragraphs [0071] and [0072].

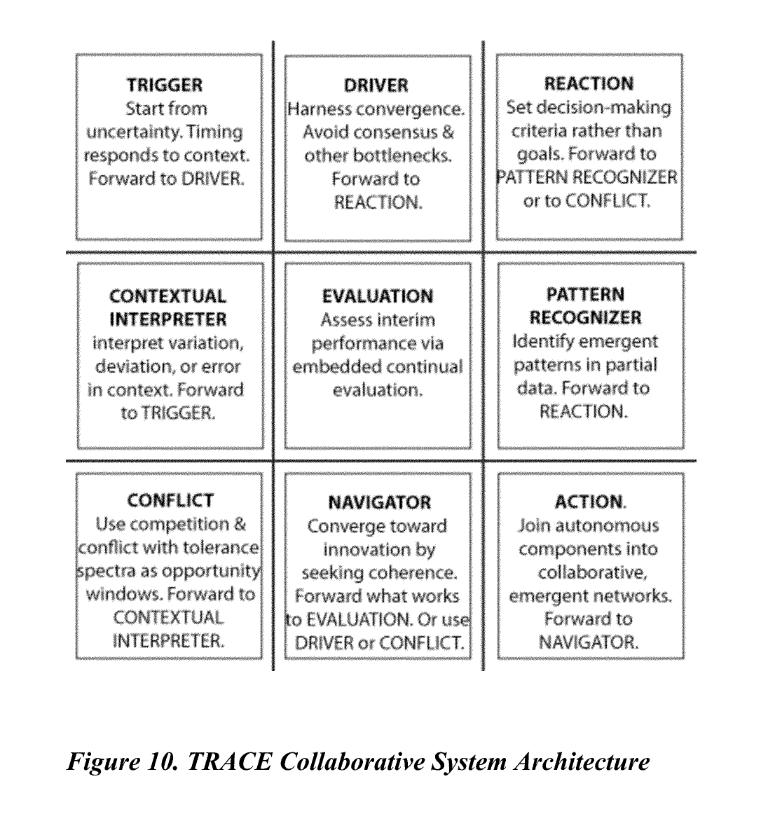

FIG. 10 shows a generic embodiment of the invention, wherein the system is comprised of nine steps, five primary steps (referred to herein as the TRACE model, acronym for the five key steps) and four supporting steps, enabling users rapidly to access prompts and log their input.
TRIGGER (top left icon)—a Task Request or Query calling for response; when a Task Requester presses the trigger button on a user interface, the system records a GPS locator and timestamp. The user enters Task Requests or other triggers to investigate: problems, questions, observations. Proceed clockwise. Forward to DRIVER.
   Driver (top middle icon)—Add details, e.g. for service provider request, urgency. Or, for collaborative tasks, team members respond to the trigger, adding relevant information from their perspectives, tasks and resources needed to address the problem. Forward to REACTION.
REACTION—In one embodiment a time window and deadlines are logged here. In other embodiments this third step identifies not only time constraints, but also other constraints and decision criteria (e.g. a medical emergency, heart attack victim). If criteria are co-dependent, they are linked. If they conflict, skip to CONFLICT. Otherwise continue to PATTERN RECOGNIZER.
   Pattern Recognizer—Responders enter suggestions and overall project status, as well as priority action items. Forward to ACTION.
ACTION—Team members identify clusters of people, resources, tasks, needs etc. to augment by clustering. Forward to NAVIGATOR.
   Navigator—Each team member distinguishes what's working from what isn't. What's working is forwarded to EVALUATION; what's not is forwarded to DRIVER or CONFLICT.
COMPETITIVE ANALYSIS—Identify and tag mutually conflicting specifications, e.g. instances where resource limitations demand tradeoffs (e.g. not enough ambulances for medical emergencies). Define tolerance windows appropriate to the problem context. Identify competition. In non-emergency response applications, such as learning applications, this step can define competitions/challenges to enlist game participation. Forward to CONTEXTUAL INTERPRETER.
   Contextual Interpreter—Choose Task Responders in one embodiment. OR collect information, assessments, and proposals from selected Responders. Each intake is logged with individual contact details, GPS, and timestamp. Forward to EVALUATION.
EVALUATION—Responder ratings may be either by number of Requests “closed” or by assessment of Task Requesters. At pre-selected time intervals, the system updates its Project Status Report. Users provide input on the status of their tasks by clicking SUBMIT and can request an UPDATE.

Furthermore, in a preferred embodiment of a reconfigurable crowd-sourcing requester-responder system and knowledge platform method to respond to requests or crowd-sourced challenges, the method comprises the steps of: (1) receiving an entry in response to a request; (2) tagging said entry into at least one of a category, group, sort, class, and, or sub-class; (3) applying an entry-forwarding rule to forward the tagged entry to at least one of a specific channel, wherein the tagged entry is expert-sourced to at least one of specific responder meeting the required credentials for a given entry; (4) tracking usage of requestor and responder by at least one of a following: identifying tags: geographic-location, timestamp, tag, and, or user profile; and (5) publishing responder entry for at least one of commenting, rating, and, or voting or retain as private based on a project requirement.

While certain exemplary embodiments have been described, and shown in the accompanying drawings, it is to be understood that such embodiments are merely illustrative and not restrictive of the broad invention, and that this invention is not limited to the specific constructions and arrangements shown and described, since various other modifications may occur to those ordinarily skilled in the art described in this disclosure. In this area of technology, where growth is fast and further advancements are not easily foreseen, the disclosed embodiments are designed to be readily modifiable in arrangement and detail to facilitate incorporating technological advancements without departing from the principles of the present disclosure and the scope of the accompanying claims.

What is claimed:

1. A reconfigurable crowd-sourcing requester-responder system and knowledge platform to respond to requests or crowd-sourced challenges, said system comprising:
a processor;
a storage element coupled to the processor;
encoded instructions;
wherein when executed, the system is configured to:
receive a request from a task requestor;
tag said request into at least one of a category, group, sort, class, and, or sub-class;
apply query-forwarding rule to forward the tagged request to at least one topic channel, wherein the tagged request is expert-sourced to at least one responder meeting the required credentials for a given request;
track usage of requesters and responders by at least one of the following identifier tags: geographic-location data, timestamp data, topic tagging, and user profile;
publish responder's entry for at least one of commenting, rating, and, or voting or maintaining anonymity of responder, as designated; and
wherein usage causes an operational state change of at least one of the query, the query-forwarding rule, credentials, and, or a project requisite.

2. The reconfigurable crowd-sourcing requester-responder system and knowledge platform of claim 1, wherein tagging generates a unique machine-readable identifier signature for every user, task knowledge resource or other entity in the system;

3. The reconfigurable crowd-sourcing requester-responder system and knowledge platform of claim 2, wherein identifiers can be clustered by topic, time, geographic location, user profile, or other sub-class of ID's such that a threshold level of similarity can be specified enabling the system to apply a matching algorithm and forwarding rule.

4. The reconfigurable crowd-sourcing requester-responder system and knowledge platform of claim 1, wherein each tag attached to an entry and, or request includes at least one of a query or entry ID; author ID; benchmarks; category & sub-category designations; channel designations; competing project IDs; context descriptors; critical path timeline; directory tags; geo-location of author at submission; geo-location of entry content; goal identifiers; impact tracker tags; incentives; key words; map IDs; matches made; metadata not included in other tags; portal designation; recommender system offers; resources; rewards; reviewer/jury comments; social networks; sub-portal designation(s); synergistic project IDs; tag collector IDs; template tag(s); time-stamping (entry time); time-stamping (benchmarks achieved); topic channels; user group IDs; user ratings; and, or workflow tags.

5. The reconfigurable crowd-sourcing requester-responder system and knowledge platform of claim 1, wherein the tags added as the entry proceeds through the system include at least one of benchmarks achieved; benchmarks revised; critical path status; footprint tags; goals achieved; goals revised; networks joined; reviewer ratings; resources tapped; networks joined; responses to recommender system; site usage time and, or click history.

6. The reconfigurable crowd-sourcing requester-responder system and knowledge platform of claim 1, wherein the tag is notated with a timestamp, enabling tracking of a critical path timeline and record benchmarks achieved and impact of work to date.

7. The reconfigurable crowd-sourcing requester-responder system and knowledge platform of claim 1, wherein the tagged entry and, or request is forwarded to at least one of a specific channel, wherein the tagged item and, or request is expert-sourced to at least one of specific project responder meeting the required credentials for a given item and, or request based on the query-forwarding rule.

8. The reconfigurable crowd-sourcing requester-responder system and knowledge platform of claim 1, wherein the forwarded tagged item and, or request is forwarded to at least one main portal, whereby the main portal represents a highest forward score as per the forwarding rule.

9. The reconfigurable crowd-sourcing requester-responder system and knowledge platform of claim 8, further comprising at least one sub-portal, whereby the sub-portal represents an above-threshold forward score, below the highest forward score, as per the forwarding rule.

10. The reconfigurable crowd-sourcing requester-responder system and knowledge platform of claim 1, wherein the main portal offers an entrant a framework to structure the entrant's entry and, or project-related query, said framework comprising of at least one of objects, attributes, procedures, networks, and assessments enabling updates and clustering of entries that are mutually synergistic.

11. The reconfigurable crowd-sourcing requester-responder system and knowledge platform of claim 10, wherein the framework starts with the entrant's description of features and advantages of the entry, defining an initial signature of the entry (identifier and first component of a user profile) and forming a base for an evolving footprint (the second component of the profile).

12. The reconfigurable crowd-sourcing requester-responder system and knowledge platform of claim 1, further comprising templates associated with each unique entry, tagged to facilitate assessing the entry relative to the request for proposals or a competition challenge.

13. The reconfigurable crowd-sourcing requester-responder system and knowledge platform of claim 1, further comprising mapping a public query onto a concept and, or geographic map.

14. The reconfigurable crowd-sourcing requester-responder system and knowledge platform of claim 1, further comprising an impact tracker, whereby said tracker performs at least one of plots, analyzes, publishes, and, or integrates to at least one of a map, database, social media, and, or automation platform.

15. The reconfigurable crowd-sourcing requester-responder system and knowledge platform of claim 1, further allowing bidding by responders in an auction-style platform.

16. The reconfigurable crowd-sourcing requester-responder system and knowledge platform of claim 1, further linking incentive offers to a given request and, or bid by a requestor and, or responder.

17. The reconfigurable crowd-sourcing requester-responder system and knowledge platform of claim 1, further comprising a request or query launched with an assigned identifier (ID), and an attached profile, enabling synergistic or competing queries to be mapped to a network, such that maps and directories linked to each entry can be revised as called for by the request profile.

18. The reconfigurable crowd-sourcing requester-responder system and knowledge platform of claim 1, further comprising launching a recommender system linking related, synergistic and/or competing users, projects, and resources, and generating new templates as needed

19. The reconfigurable crowd-sourcing requester-responder system and knowledge platform of claim 1, further comprising templates associated with each unique competition entry, tagged to facilitate assessing the competition entry relative to a request for proposals or competition challenge.

20. The crowd-sourcing requester-responder system and knowledge platform of claim 1, further linking user ratings and rewards to project outcomes, which may either be published or private to the system.

21. A reconfigurable crowd-sourcing requester-responder system and knowledge platform to respond to requests or crowd-sourced challenges, said system comprising:
a processor;
a storage element coupled to the processor;
encoded instructions;
wherein when executed, the system is configured to:
receive a request from a task requestor;
tag said request into at least one of a category, group, sort, class, and, or sub-class;
apply query-forwarding rule to forward the tagged request to at least one topic channel, wherein the tagged request is expert-sourced to at least one responder meeting the required credentials for a given request;
track usage of requesters and responders by at least one of the following identifier tags: geographic-location data, timestamp data, topic tagging, and user profile;
publish responder's entry for at least one of commenting, rating, and, or voting or maintaining anonymity of responder, as designated;
said response comprised of a competition entry relative to a request for a proposal and, or competition challenge;
whereby the competition entry is assigned a score, as per a bidding and, or auction rule, and said competition entry is linked to an incentive and, or reward system; and
wherein usage causes an operational state change of at least one of the query, the query-forwarding rule, credentials, project requisite, bidding rule, auction rule, incentive system, and, or reward system.

22. A reconfigurable crowd-sourcing requester-responder system and knowledge platform method to respond to requests or crowd-sourced challenges, said method comprising the steps of:
receiving an entry in response to a request;
tagging said entry into at least one of a category, group, sort, class, and, or sub-class;
applying an entry-forwarding rule to forward the tagged entry to at least one of a specific channel, wherein the tagged entry is expert-sourced to at least one of specific responder meeting the required credentials for a given entry;
tracking usage of requestor and responder by at least one of a following: identifying tags: geographic-location, timestamp, tag, and, or user profile; and
publishing responder entry for at least one of commenting, rating, and, or voting or retain as private based on a project requirement.
